(19) United States
(12) Patent Application Publication
(10) Pub. No.: US 2024/0368887 A1
(43) Pub. Date: Nov. 7, 2024

(54) RIB FOR STRUCTURAL INSULATED PANEL AND METHODS THEREOF

(71) Applicant: NEXII BUILDING SOLUTIONS INC., Vancouver (CA)

(72) Inventors: Michael Dombowsky, Moose Jaw (CA); Braden Dombowsky, Peachland (CA)

(21) Appl. No.: 18/654,814

(22) Filed: May 3, 2024

Related U.S. Application Data
(60) Provisional application No. 63/464,131, filed on May 4, 2023.

(51) Int. Cl. E04C 2/38; B32B 3/06; B32B 3/08; B32B 3/26; B32B 3/30; B32B 13/04; B32B 13/10; B32B 13/14; E04B 2/00; E04B 5/02; E04C 2/00; E04C 2/288

(52) U.S. Cl. CPC E04C 2/384; B32B 3/06; B32B 3/08; B32B 3/263; B32B 3/30; B32B 13/045; B32B 13/10; B32B 13/14; E04C 2/288; E04C 2/388; B32B 2250/40; B32B 2307/102; B32B 2307/304; B32B 2607/00; E04C 2002/001; E04C 2/46; E04C 2/50

(57) ABSTRACT

Prefabricated structural insulated panels (SIPs) and methods thereof. An example SIP comprises an insulative core having a first face, a second face opposite the first face and a plurality of peripheral edge faces extending between the first and second faces. A first cementitious layer may at least partially cover the first face of the insulative core. A first rib may be coupled to and extend at least partially along a first peripheral edge face of the plurality of peripheral edge faces. The rib may comprise a first casing having an open end proximate to the insulative core and an opposing closed end distal to the insulative core. The rib may also comprise a first cementitious material within a cavity defined by the first casing and the first peripheral edge face. The first cementitious material may at least partially couple the first casing to the insulative core.

### REFERENCE TO RELATED APPLICATIONS

This application claims the benefit under 35 USC § 119 of U.S. application No. 63/464,131 filed 4 May 2023 and entitled RIB FOR STRUCTURAL INSULATED PANEL AND METHODS THEREOF which is incorporated herein by reference for all purposes.

### FIELD

This invention relates to building panels and in particular cementitious prefabricated building panels such as Structural Insulated Panels (SIPs). Example embodiments provide one or more ribs that are coupled to a SIP and methods for fabricating such SIPs.

### BACKGROUND

Constructing a building is typically an extensive project involving significant amounts of time and/or resources (labour, energy, materials, etc.). Moreover, the carbon footprint of a building built using existing systems and methods can be large.

Reducing the amount of time and/or resources required to construct a building can be desirable. Reducing the carbon footprint of a building can also be desirable. With more environmentally stringent building codes being passed regularly, reducing the amount of resources used to construct a building and the carbon footprint of the building is increasingly becoming a requirement to be in compliance with new building codes.

One way the amount of time and/or resources required can be reduced is by constructing the building using prefabricated panels. Existing prefabricated panels however are heavy, cannot provide the required performance characteristics, etc. Additionally, existing prefabricated panels may be difficult to maneuver into place and to couple together. Additionally, existing prefabricated panels may include large amounts of steel, concrete, etc. making such panels be high in embodied carbon.

There remains a need for practical and cost effective ways to construct prefabricated building panels using systems and methods that improve on existing technologies. Additionally, there remains a need for lower embodied carbon prefabricated building panels.

### SUMMARY

This invention has a number of aspects. These include, without limitation:
composite ribs for achieving desired performance characteristics of a prefabricated panel;
methods for constructing a prefabricated panel.

One aspect of the invention provides a prefabricated structural insulated panel (SIP). The SIP may comprise an insulative core having a first face, a second face opposite the first face and a plurality of peripheral edge faces extending between the first and second faces. The SIP may also comprise a first cementitious layer at least partially covering the first face of the insulative core. The SIP may also comprise a first rib coupled to and extending at least partially along a first peripheral edge face of the plurality of peripheral edge faces. The first rib may comprise a first casing having an open end proximate to the insulative core and an opposing closed end distal to the insulative core. The first rib may also comprise a first cementitious material within a cavity defined by the first casing and the first peripheral edge face. The first cementitious material may at least partially couple the first casing to the insulative core.

In some embodiments the first casing of the first rib comprises one or more texturing members extending from the first casing into the cavity of the first rib. The texturing members may be configured to increase shear strength of a bond between the first casing and the first cementitious material.

In some embodiments the texturing members comprise embossments or protrusions in the first casing or fasteners coupled to the first casing.

In some embodiments at least one of the fasteners is embedded at least partially within the first cementitious layer.

In some embodiments the first cementitious material forms a wet bond with at least one of the first casing and the insulative core.

In some embodiments the first casing is C-shaped.

In some embodiments the first casing comprises a light gauge steel stud.

In some embodiments the first casing comprises a fibre reinforced plastic (FRP) casing.

In some embodiments the first cementitious material is the same as the cementitious material of the first cementitious layer.

In some embodiments the first rib comprises at least one coupling element extending through the cavity of the first rib and at least partially embedded within the first cementitious layer. The coupling element may at least partially reduce shear separation of the first rib from the insulative core.

In some embodiments the coupling element comprises glass knitted mesh (GKM).

In some embodiments the first rib comprises at least one reinforcing element within the cavity of the first rib.

In some embodiments the at least one reinforcing element is at least partially embedded within the first cementitious material of the first rib.

In some embodiments the first rib comprises at least one filler member within the cavity of the first rib. The filler member may reduce a volume of the cavity of the first rib.

In some embodiments the SIP comprises a structural frame and the first rib is integrated into the structural frame.

In some embodiments the SIP comprises at least one connector coupled to the first rib. The connector may be configured to couple the SIP to an adjacent SIP or a building structure.

In some embodiments the SIP comprises a thermal break at least partially coupled to the first rib.

In some embodiments the SIP comprises a second rib coupled to and extending at least partially along a second peripheral edge face of the plurality of peripheral edge faces. The second rib may comprise a second casing having an open end proximate to the insulative core and an opposing closed end distal to the insulative core. The second rib may also comprise a second cementitious material within a cavity defined by the second casing and the second peripheral edge face. The second cementitious material may at least partially couple the second casing to the insulative core.

In some embodiments the first and second ribs are coupled together.

In some embodiments the second rib is the same as the first rib.

In some embodiments the SIP comprises a second cementitious layer at least partially covering the second face of the insulative core.

In some embodiments the first rib is at least partially embedded within the insulative core.

Another aspect of the invention provides a method for fabricating a structural insulated panel (SIP). The method may comprise: positioning one or more casings along a periphery of a casting form; casting a first cementitious layer; embedding a first face of an insulative core having first and second opposing faces into the first cementitious layer; and filling one or more cavities formed between the one or more casings and the insulative core with a cementitious material.

In some embodiments the method comprises at least partially embedding at least one coupling element which extends through the one or more cavities into the first cementitious layer prior to embedding the first face of the insulative core into the first cementitious layer.

In some embodiments the method comprises casting a second cementitious layer to at least partially cover the second face of the insulative core.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1A is a schematic cut-away perspective view of example components of a prefabricated structural insulated panel (SIP).

FIG. 1B is a cross-sectional view of the example components of FIG. 1A.

FIG. 1C is a schematic cut-away perspective view of an example SIP comprising one or more example ribs.

FIG. 1D is a cross-sectional view of the example SIP of FIG. 1C.

FIG. 2 is a partial cross-sectional view of a SIP comprising one or more example ribs.

FIG. 3 is a partial cross-sectional view of a SIP comprising one or more example ribs.

FIG. 4 is a partial cross-sectional view of a SIP comprising one or more example ribs.

FIG. 5 is a partial cross-sectional view of a SIP comprising one or more example ribs.

FIG. 6 is a partial perspective view of an example casing of a rib.

FIG. 7 is a schematic cut-away perspective view of an example SIP comprising one or more example ribs.

FIG. 8 is a schematic cut-away perspective view of an example SIP comprising one or more example ribs.

FIG. 9 is a cross-sectional view of an example SIP comprising one or more example ribs.

FIG. 10 is a block diagram of an example method.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

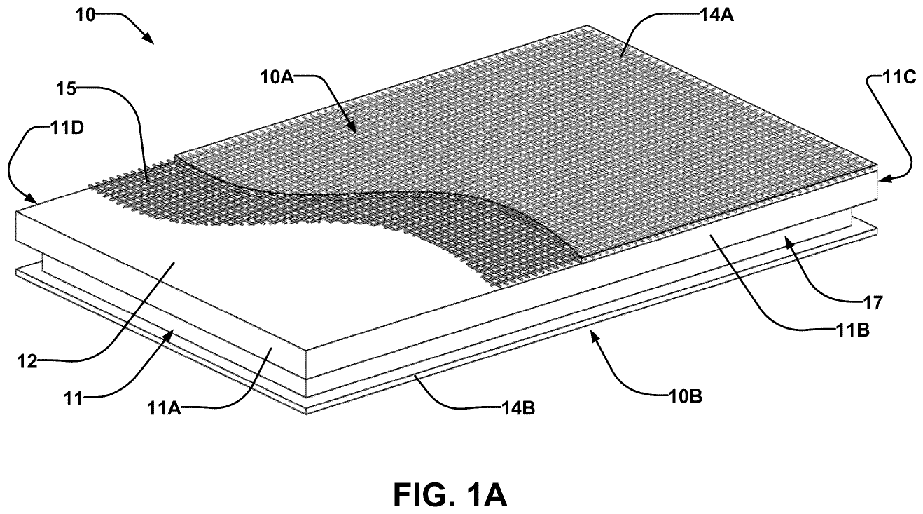

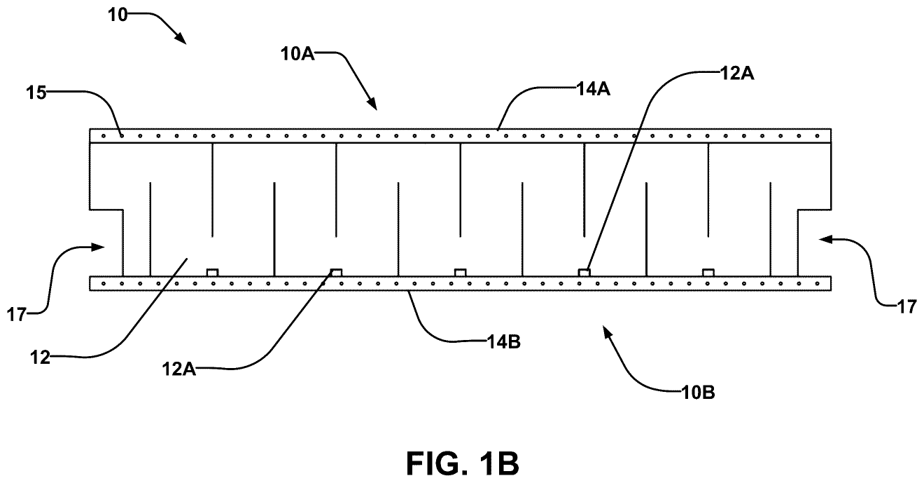

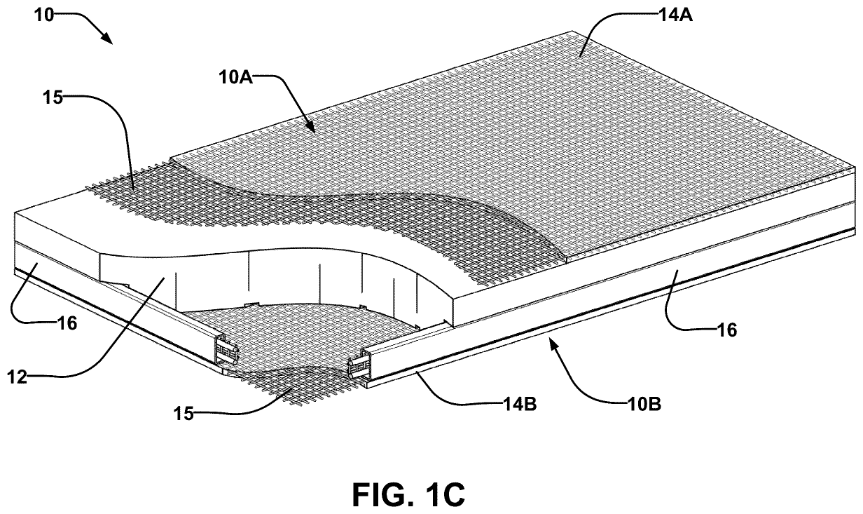

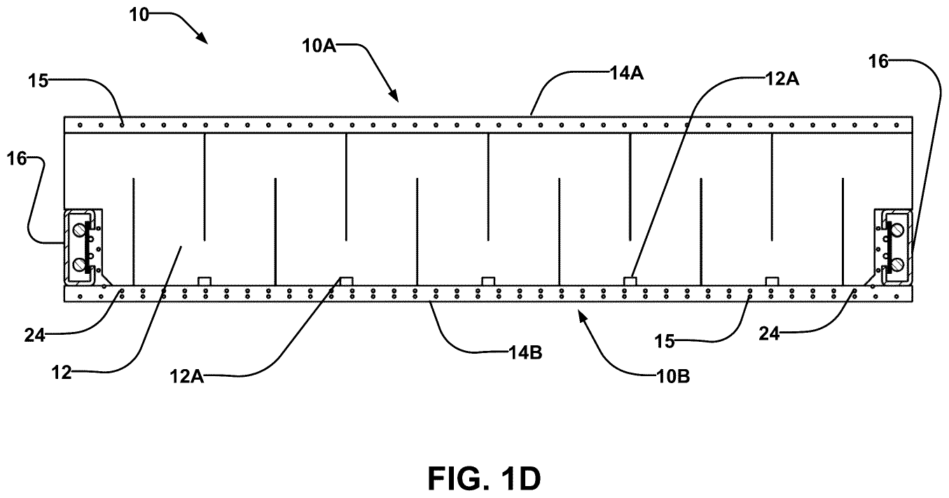

FIGS. 1A to 1D illustrate an example structural insulated panel (SIP) 10. FIG. 1B is a cross-sectional view of the panel 10 components of FIG. 1B. FIG. 1D is a cross-sectional view of the panel 10 of FIG. 1C.

Panel 10 has opposing faces 10A and 10B. A set of panels 10 may be used to construct a building, to insulate an existing building and/or the like. Preferably panels 10 are plant finished (e.g. fully manufactured at a factory). Panels 10 may preferably be easily and quickly shipped to a construction site (e.g. on a flatbed truck, within shipping containers, on railway cars, etc.). Panels 10 may, for example, comprise wall panels, roof panels, floor panels, foundation panels, etc. Once panels 10 arrive at the construction site they may be easily and quickly assembled together.

Panel 10 comprises a periphery 11. In the example embodiment illustrated in FIG. 1A periphery 11 comprises edge faces 11A, 11B, 11C and 11D which extend between opposing faces 10A and 10B.

Panel 10 comprises an insulative core 12. Insulative core 12 provides thermal insulation for panel 10. Insulative core 12 may at least partially structurally support panel 10. Insulative core 12 may at least partially dampen sound transmission through panel 10. Insulative core 12 preferably comprises a single piece of insulation. However, insulative core 12 comprising a single piece of insulation is not mandatory. In some embodiments insulative core 12 is made of two or more pieces of insulation. In some embodiments insulative core 12 comprises a core formed from an injectable material. In some embodiments the injectable material comprises an expandable material (e.g. expandable polyurethane or the like). In some embodiments insulative core 12 comprises a core formed from a loose filled insulation that solidifies such as hempcrete, foamed concrete and/or the like. In some embodiments insulative core 12 comprises fiberglass insulation, hemp rock wool batt insulation, cellulose insulation and/or the like.

Insulative core 12 may comprise grooves 12A. Grooves 12A may, for example, assist with drainage of moisture away from insulative core 12. Grooves 12A may, for example, be located proximate to an exterior face of panel 10.

At least one of faces 10A and 10B of panel 10 is at least partially covered by a cementitious layer 14. Cementitious layer 14 may be wet-bonded to the surface(s) of insulative core 12 (e.g. the cementitious layer “self-adheres” to the surface(s) of insulative core 12). In some embodiments both of faces 10A and 10B of panel 10 are covered by a cementitious layer 14 (e.g. cementitious layers 14A and 14B as shown in FIGS. 1A-1D). Reinforcement 15 (e.g. a reinforcing mesh, reinforcing fibers, etc.) may be embedded within a cementitious layer 14.

For the purposes described herein a “wet bond” may provide an adhesive chemical bond directly between two surfaces that are to be coupled together (e.g. a face of the insulative core and a cementitious layer).

One or more ribs 16 (e.g. as shown in FIGS. 1C and 1D) may be coupled to one or more edge faces of periphery 11 of panel 10. A rib 16 may but need not extend fully along an edge face of panel 10. In some embodiments ribs 16 fully enclose periphery 11 of panel 10. Two adjacent ribs may be coupled together. In some embodiments at least one rib 16 is integrated into a structural frame which encloses periphery 11 of panel 10. The frame may, for example, comprise HSS steel, steel I-beams and/or the like. Integrating one or more ribs 16 into a structural frame of panel 10 may advantageously reduce weight of the structural frame while achieving a desired strength performance.

One or more ribs 16 may or may not extend along an entire width or length of an edge face of periphery 11. In some embodiments one or more ribs 16 may only extend partially along a width or length of an edge face of periphery 11 (see e.g. FIGS. 1C and 1D). In some embodiments one or more ribs 16 are at least partially embedded within insulative core 12. In some embodiments one or more ribs 16 are embedded within insulative core 12 (or panel 10) such that an outermost surface of the one or more ribs 16 is flush with an outermost surface of insulative core 12 and/or cementitious layers 14A, 14B and/or another surface of panel 10 of the respective edge face (see e.g. FIGS. 1C and 1D). In some embodiments a rib 16 is embedded within a corresponding recess 17. Recess 17 may, for example, be within insulative core 12.

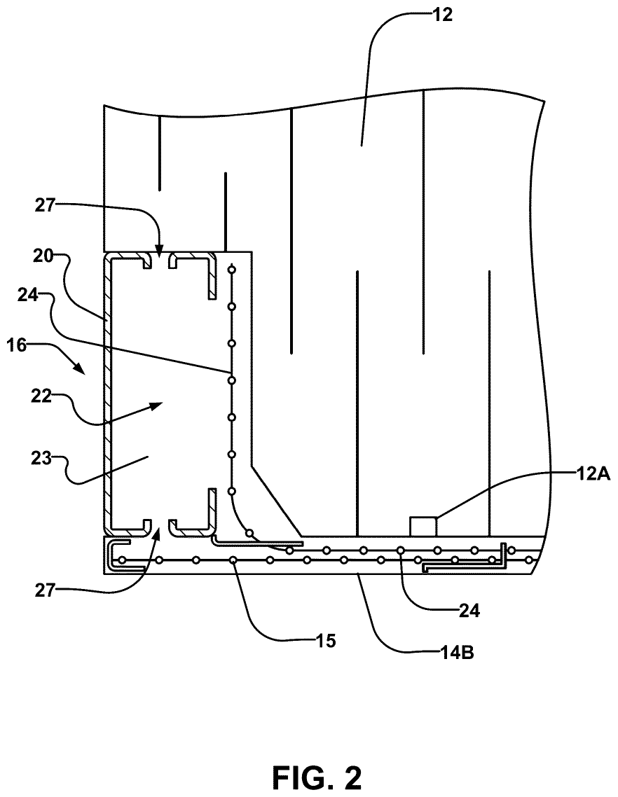

As shown in FIG. 2, rib 16 comprises a casing 20. In some embodiments casing 20 comprises a cold formed steel profile. In some embodiments casing 20 is C-shaped (e.g. comprises 3 sides). However, casing 20 need not be C-shaped in all embodiments. In some embodiments casing 20 comprises a steel stud. In some embodiments the steel stud comprises a light gauge steel stud (e.g. a gauge value in a range from about 24 gauge to about 12 gauge such as 18 gauge). In some embodiments casing 20 comprises a fibre reinforced plastic (FRP) casing.

In some embodiments cavity 22 formed between casing 20 and insulative core 12 is filled with a cementitious material 23. Cementitious material 23 may be the same or different than the cementitious material of a cementitious layer 14. Internal wall surfaces of casing 20 and/or peripheral edge surfaces of insulative core 12 may at least partially function as formwork allowing cementitious material 23 to set.

In some embodiments cementitious material 23 bonds casing 20 (and rib 16) to insulative core 12. In some embodiments cementitious material 23 forms a wet bond (as described elsewhere herein) with insulative core 12 and/or casing 20.

A bond of rib 16 to insulative core 12 may be strengthened by one or more coupling elements 24. For example, a coupling element 24 may be partially embedded within a first cementitious layer (e.g. cementitious layer 14A), wrap around insulative core 12 and through cavity 22 and be at least partially embedded within a second cementitious layer (e.g. cementitious layer 14B). In some embodiments coupling element 24 comprises a reinforcing mesh such as wire-welded mesh, a glass knitted mesh (GKM) and/or the like. In some embodiments a coupling element 24 comprises a plurality of pieces or components (e.g. a plurality of sheets of GKM). Coupling element(s) 24 advantageously may reduce (or prevent) shear separation of rib 16 relative to insulative core 12. In some embodiments coupling element(s) 24 are at least partially embedded within only one cementitious layer (e.g. one of cementitious layers 14A and 14B).

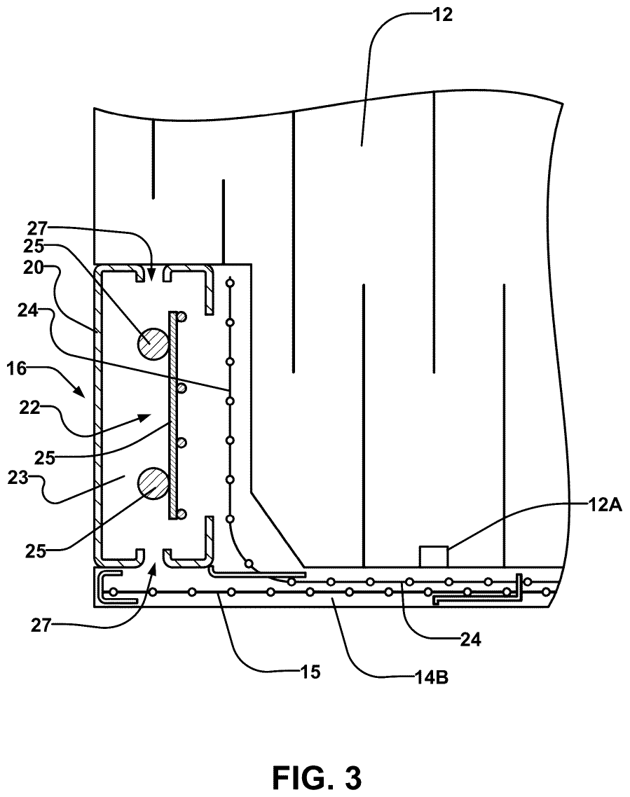

In some embodiments cavity 22 and/or cementitious material 23 comprises one or more reinforcing elements 25 such as re-bar, reinforcing fibers (e.g. a plurality of polymer fibers, a plurality of fiberglass fibers, a plurality of basalt fibers, a plurality of carbon fiber fibers, etc.), reinforcing mesh, combinations of two or more of the aforementioned elements (e.g. reinforcing mesh coupled between two re-bar rods (see e.g. FIG. 3), etc.) and/or the like. Reinforcing elements 25 may increase an overall strength (e.g. at least one of sheer, compressive, stiffness and tensile strength) of rib 16.

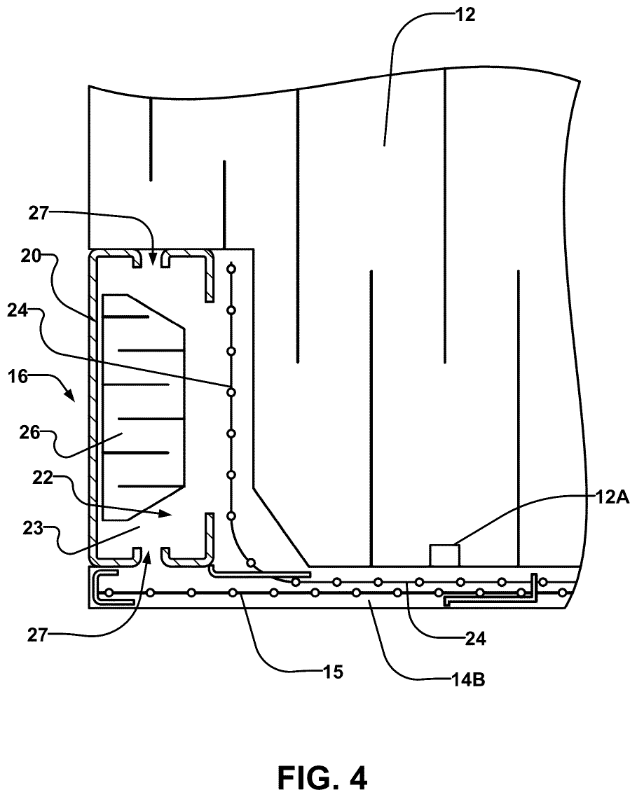

In some embodiments the strength of rib 16 may intentionally be reduced. Reducing the strength of rib 16 may reduce costs, weight of rib 16, an amount of embodied carbon of rib 16, etc. In some such embodiments cavity 22 comprises one or more filler members 26 as shown in FIG. 4. For example, filler member 26 may comprise EPS foam and/or the like. In some embodiments filler member 26 comprises the same material as insulative core 12. Filler member 26 reduces a volume of cavity 22 thereby reducing an amount of cementitious material 23 that is required to fill cavity 22. Reducing an amount of cementitious material 23 advantageously reduces the weight of panel 10. Additionally, or alternatively, reducing an amount of cementitious material 23 may advantageously reduce embodied carbon of panel 10. Cementitious material 23 may at least partially bond (e.g. with a wet bond) filler member 26 with one or more members or elements of rib 16.

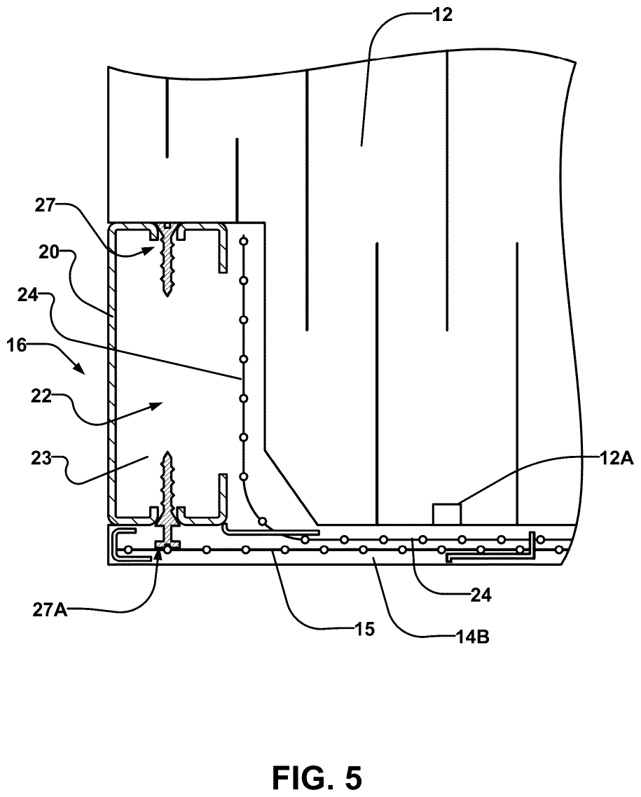

In some embodiments, as shown in FIG. 5, casing 20 may comprise one or more texturing members 27 which extend from casing 20 into cavity 22 which increase the shear transfer of the bond between casing 20 and cementitious material 23. For example, texturing members 27 may comprise embossments, apertures, embossments with apertures, protrusions, protrusions with apertures, pins, screws, shear screws, any combination of two or more of the aforementioned items and/or the like. Texturing members 27 may reduce the likelihood (or prevent) shear separation of casing 20 and cementitious material 23.

In some embodiments one or more texturing members 27 at least partially additionally strengthen a bond between casing 20 and one or both of cementitious layers 14A and 14B. In some embodiments one or more texturing members 27 may at least partially extend outwardly from casing 20. For example texturing members 27 may comprise one or more fasteners (e.g. screws, bolts, shear screws, etc.) or the like which at least partially extend outwardly from casing 20 (see e.g. fastener 27A in FIG. 5). The portion of the one or more fasteners which extends outwardly from casing 20 may be embedded in cementitious layer 14A or 14B. Embedding one or more texturing members 27 in cementitious layer 14A and/or 14B strengthens a bond between cementitious layer 14A and/or 14B and casing 20.

A rib 16 may comprise any combination of any of cementitious material 23, one or more coupling elements 24, one or more reinforcing elements 25, one or more filler members 26 and one or more texturing members 27.

Two ribs 16 of a panel 10 may, for example, comprise different structures.

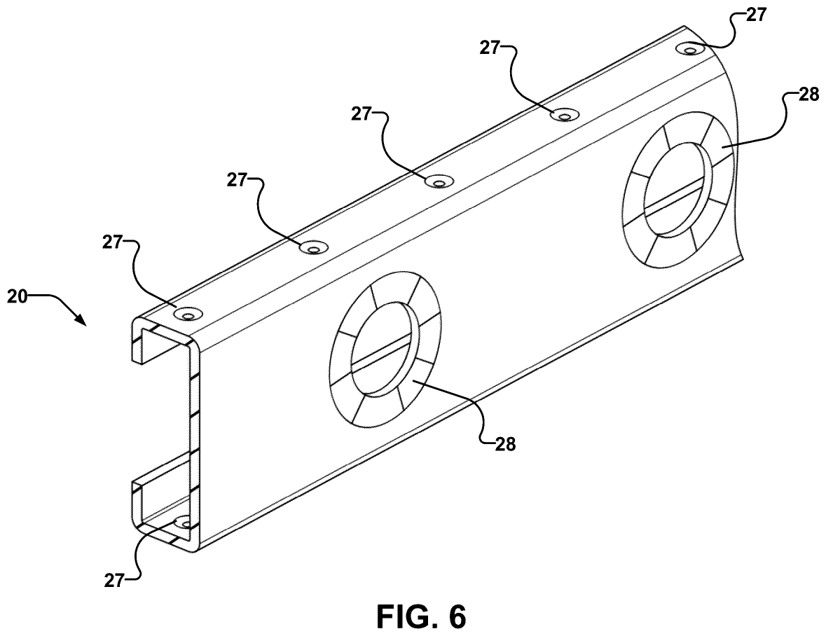

FIG. 6 is a partial perspective view of an example casing 20 of a rib 16. Casing 20 may additionally, or alternatively, comprise one or more joint texturing members 28 (e.g. embossments, embossments with apertures, protrusions, protrusions with apertures, etc.). Joint texturing members 28 may increase shear transfer of a bond formed between opposing faces of adjacent ribs 16 (e.g. opposing ribs 16 of adjacent panels 10, opposing ribs 16 within a panel 10, etc.) and a binder (e.g. a cementitious material, an adhesive, silicone caulking and/or the like) introduced between the opposing adjacent ribs 16. The binder may, for example, seal a joint between the opposing adjacent ribs 16 (e.g. a joint between adjacent roof panels).

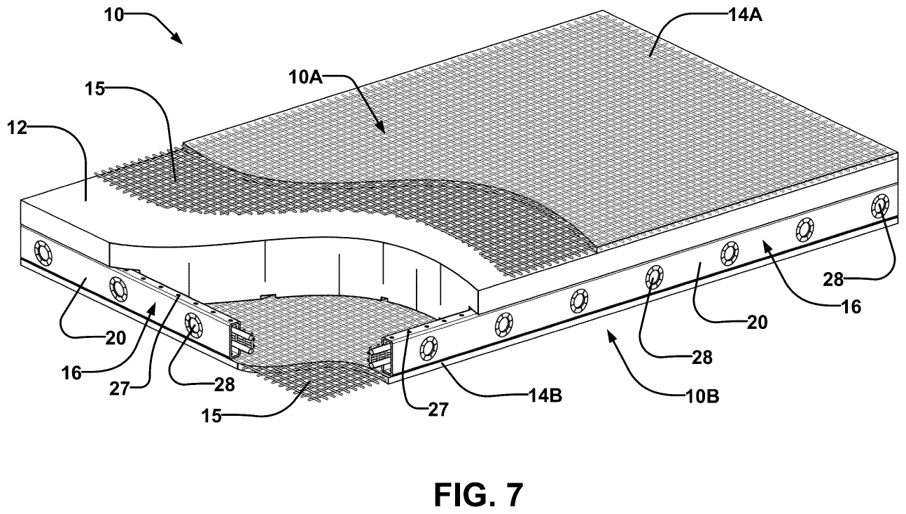

FIG. 7 illustrates a schematic cut-away perspective view of an example panel 10 comprising ribs 16 comprising joint texturing members 28.

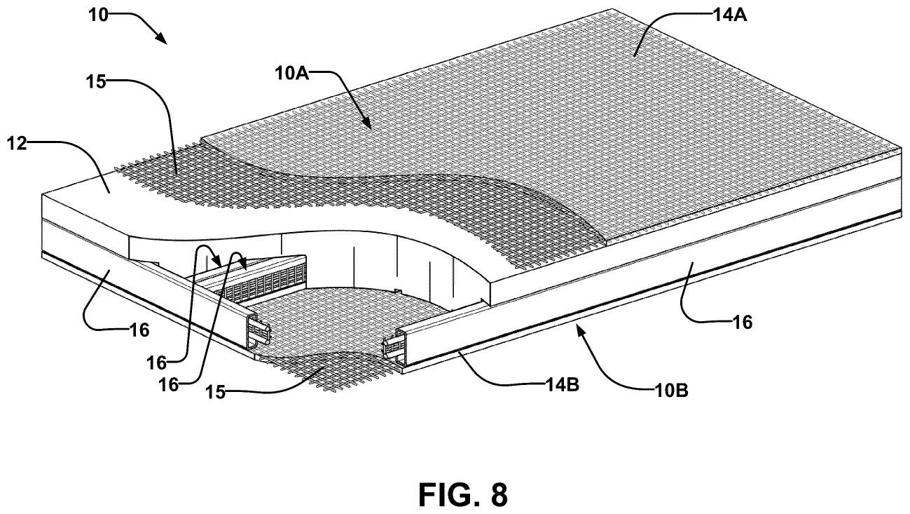

As shown in FIG. 8, panel 10 may comprise one or more ribs 16 which extend through insulative core 12 and/or panel 10. Such ribs 16 may, for example, be positioned along a centerline of panel 10, at quarter points of panel 10, at set spacing distances (e.g. 12 inches on center, 16 inches on center, 24 inches on center, etc.), etc. In some embodiments such ribs 16 extend through insulative core 12 from a first face of insulative core 12 to a second opposing face of insulative core 12.

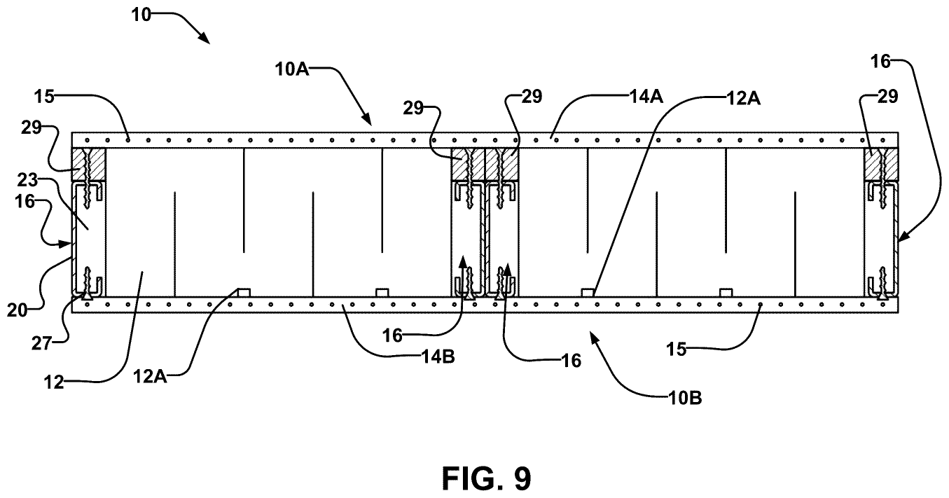

In some embodiments two ribs 16 are positioned adjacent one another within panel 10 (e.g. see also FIG. 9). Casings 20 of two adjacent ribs 16 may be coupled together with, for example, an adhesive, a bonding agent, a fastening mechanism, etc. Coupling casings 20 together may increase stiffness of the adjacent ribs 16 and thereby increases stiffness of panel 10. Casings 20 of two adjacent ribs 16 may, for example, be positioned such that the casings 20 oppose one another (e.g. respective faces oppose one another) (see e.g. FIG. 9) however this is not necessary in all cases.

In some embodiments panel 10 comprises one or more thermal breaks 29 (see e.g. FIG. 9). A thermal break 29 may, for example, comprise a high density thermal breaking material such as type 4 expanded polystyrene (EPS), Coosa™ board and/or the like. In some embodiments a thermal break 29 is at least partially coupled to a corresponding rib 16. For example, a thermal break 29 may be coupled to a corresponding rib 16 with a fastener or the like. In some embodiments a thermal break 29 is at least partially coupled to a casing 20 of a corresponding rib 16. Thermal break 29 may advantageously perform well under compression and/or under tension.

Insulative core 12 typically has an insulative R-value of about R4 per inch. In some embodiments insulative core 12 has an insulative R-value of at least R12. In some embodiments insulative core 12 has an insulative R-value of at least R96. In some embodiments insulative core 12 has an insulative R-value between R12 and R96.

In some embodiments at least one cementitious material described herein has a density in the range of 5 to 35 MPA. In some embodiments at least one cementitious material has a density in the range of 35 to 90 MPA. In some embodiments at least one cementitious material has a density in the range of 90 to 200 MPA.

Panel 10 may comprise at least one connector. The connector may facilitate coupling of the panel to a building, coupling of the panel to other panels, maneuvering of the panel during construction (e.g. provides an attachment point for a hoist, etc.), etc. In some embodiments one or more connectors are coupled to one or more ribs 16.

In some embodiments the connector comprises at least one aperture for receiving a connecting element (i.e. an element used to couple the connector to another component of the structure under construction). In some embodiments the connector comprises a cavity through which the connecting element may be accessed (e.g. to couple a nut to the end of the connecting element). In some embodiments the connector is a hollow steel element (e.g. a hollow rectangular steel section). In some embodiments the connector is like the connector(s) described in PCT International Publication No. WO 2021/195790 published on 7 Oct. 2021 and titled SYSTEMS AND METHODS FOR COUPLING PREFABRICATED PANELS TOGETHER AND REINFORCING FRAME STRUCTURE, which is hereby incorporated by reference for all purposes. In some embodiments the connector is like the connector(s) described in U.S. patent application Ser. No. 18/095,918 filed on 11 Jan. 2023 and titled SYSTEMS AND METHODS FOR COUPLING PREFABRICATED PANELS TO STRUCTURES.

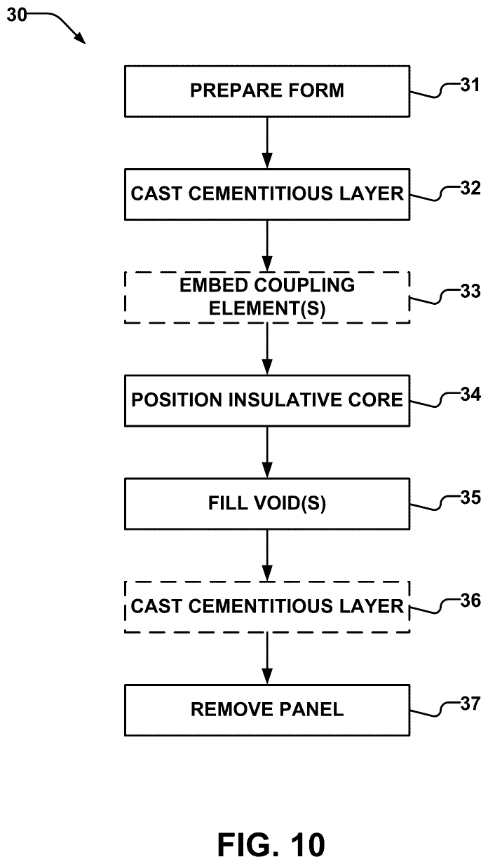

FIG. 10 illustrates an example method 30 for fabricating an example panel 10 as described herein.

In block 31 a form for casting the panel is prepared and one or more casings (e.g. casings 20) are positioned, for example, along a periphery of the form. One or more reinforcing elements, filler members and/or texturing members may be pre-installed or pre-coupled to the one or more casings prior to or upon the one or more casings being positioned within the form.

In block 32 a cementitious material is cast (e.g. to form a first cementitious layer of the panel).

While the cast cementitious material is still at least partially uncured one or more coupling elements (e.g. coupling elements 24) may optionally be at least partially embedded in the cast cementitious material in block 33.

In block 34 an insulative core (e.g. insulative core 12) may be positioned within the form and the at least partially uncured cast cementitious material (e.g. a face of the insulative core may be placed into contact with the cementitious material). In some embodiments one or more coupling elements (e.g. coupling elements 24) are pre-coupled to the insulative core prior to the insulative core being positioned into the form (e.g. GKM may be wrapped around the insulative core).

In block 35 voids between the insulative core and the one or more casings are filled with cementitious material thereby coupling the casings to the cementitious material.

In block 36 cementitious material is optionally cast over at least a portion of a second opposing face of the insulative core (e.g. to form a second cementitious layer of the panel).

Once the cementitious material is sufficiently cured, the panel may be removed from the form in block 37.

Where a component (e.g. a reinforcing element, a coupling element, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A prefabricated structural insulated panel (SIP) comprising:
an insulative core having a first face, a second face opposite the first face and a plurality of peripheral edge faces extending between the first and second faces;
a first cementitious layer at least partially covering the first face of the insulative core;
a first rib coupled to and extending at least partially along a first peripheral edge face of the plurality of peripheral edge faces, the first rib comprising:
a first casing having an open end proximate to the insulative core and an opposing closed end distal to the insulative core; and
a first cementitious material within a cavity defined by the first casing and the first peripheral edge face, the first cementitious material at least partially coupling the first casing to the insulative core.

2. The SIP of claim 1 wherein the first casing of the first rib comprises one or more texturing members extending from the first casing into the cavity of the first rib, the texturing members configured to increase shear strength of a bond between the first casing and the first cementitious material.

3. The SIP of claim 2 wherein the texturing members comprise embossments or protrusions in the first casing or fasteners coupled to the first casing.

4. The SIP of claim 3 wherein at least one of the fasteners is embedded at least partially within the first cementitious layer.

5. The SIP of claim 1 wherein the first cementitious material forms a wet bond with at least one of the first casing and the insulative core.

6. The SIP of claim 1 wherein the first casing is C-shaped.

7. The SIP of claim 1 wherein the first casing comprises a light gauge steel stud.

8. The SIP of claim 1 wherein the first casing comprises a fibre reinforced plastic (FRP) casing.

9. The SIP of claim 1 wherein the first cementitious material is the same as the cementitious material of the first cementitious layer.

10. The SIP of claim 1 wherein the first rib comprises at least one coupling element extending through the cavity of the first rib and at least partially embedded within the first cementitious layer, the coupling element at least partially reducing shear separation of the first rib from the insulative core.

11. The SIP of claim 10 wherein the coupling element comprises glass knitted mesh (GKM).

12. The SIP of claim 1 wherein the first rib comprises at least one reinforcing element within the cavity of the first rib.

13. The SIP of claim 12 wherein the at least one reinforcing element is at least partially embedded within the first cementitious material of the first rib.

14. The SIP of claim 1 wherein the first rib comprises at least one filler member within the cavity of the first rib, the filler member reducing a volume of the cavity of the first rib.

15. The SIP of claim 1 wherein the SIP comprises a structural frame and the first rib is integrated into the structural frame.

16. The SIP of claim 1 comprising at least one connector coupled to the first rib, the connector configured to couple the SIP to an adjacent SIP or a building structure.

17. The SIP of claim 1 comprising a thermal break at least partially coupled to the first rib.

18. The SIP of claim 1 comprising a second rib coupled to and extending at least partially along a second peripheral edge face of the plurality of peripheral edge faces, the second rib comprising:
a second casing having an open end proximate to the insulative core and an opposing closed end distal to the insulative core; and
a second cementitious material within a cavity defined by the second casing and the second peripheral edge face, the second cementitious material at least partially coupling the second casing to the insulative core.

19. The SIP of claim 18 wherein the first and second ribs are coupled together.

20. The SIP of claim 18 wherein the second rib is the same as the first rib.

21. The SIP of claim 1 comprising a second cementitious layer at least partially covering the second face of the insulative core.

22. The SIP of claim 1 wherein the first rib is at least partially embedded within the insulative core.

23. A method for fabricating a structural insulated panel (SIP) comprising:
positioning one or more casings along a periphery of a casting form;
casting a first cementitious layer;
embedding a first face of an insulative core having first and second opposing faces into the first cementitious layer; and
filling one or more cavities formed between the one or more casings and the insulative core with a cementitious material.

24. The method of claim 23 comprising at least partially embedding at least one coupling element which extends through the one or more cavities into the first cementitious layer prior to embedding the first face of the insulative core into the first cementitious layer.

25. The method of claim 23 comprising casting a second cementitious layer to at least partially cover the second face of the insulative core.
